(19) United States
(12) Patent Application Publication
(10) Pub. No.: US 2016/0161897 A1
(43) Pub. Date: Jun. 9, 2016

(54) IMAGE FORMING APPARATUS AND METHOD OF OPERATING THE SAME

(71) Applicant: SAMSUNG ELECTRONICS CO., LTD., Suwon (KR)

(72) Inventors: Hyoung-il KIM, Suwon (KR); Young-jun SHIM, Suwon (KR); Yong-ho YOU, Seoul (KR); Young-jung YUN, Suwon (KR)

(73) Assignee: SAMSUNG ELECTRONICS CO., LTD., Suwon (KR)

(21) Appl. No.: 14/867,543

(22) Filed: Sep. 28, 2015

(30) Foreign Application Priority Data
Dec. 5, 2014 (KR) 10-2014-0174290

(51) Int. Cl. G03G 15/00

(52) U.S. Cl. CPC G03G 15/757

(57) ABSTRACT

Provided is an image forming apparatus including: a feeding unit configured to feed a recording medium; an image forming unit configured to form an image on the recording medium; a fuser configured to fuse the image formed on the recording medium; a discharging unit configured to discharge the recording medium; a motor configured to drive at least one of the feeding unit, the image forming unit, the fuser, and the discharging unit, and comprise a rotor including at least one pair of permanent magnets and a Hall sensor measuring a position of the permanent magnets; and a controller configured to drive the motor based on a signal received from the Hall sensor.

### CROSS-REFERENCE TO RELATED APPLICATION

This application claims the benefit of Korean Patent Application No. 10-2014-0174290, filed on Dec. 5, 2014, in the Korean Intellectual Property Office, the disclosure of which is incorporated herein in its entirety by reference.

### BACKGROUND

1. Field

One or more exemplary embodiments relate to an image forming apparatus and a method of operating the image forming apparatus.

2. Description of the Related Art

An image forming apparatus includes driven objects that are rotated in connection with a motor. The motor is rotated in the image forming apparatus by applying a current to the motor. The driven objects connected to the motor rotate when the motor rotates. The image forming apparatus rotates the driven objects at a desired speed, and checks an operating state of the driven objects.

The motor included in the image forming apparatus may be forcibly aligned by applying a D-axis current. That is, the image forming apparatus applies a direct current (DC) to the motor to align the motor to a desired position. The motor then may rotate in a forward or reverse direction, and driven objects connected to the motor may also rotate in a forward or reverse direction. However, if the driven objects should not rotate in a reverse direction, an abnormal state may occur in the image forming apparatus due to forcible alignment of the motor.

### SUMMARY

One or more exemplary embodiments include an image forming apparatus controlling a motor via phase control.

One or more exemplary embodiments include an image forming apparatus, in which driven objects are rotated at the same rotational ratio as a motor.

Additional aspects will be set forth in part in the description which follows and, in part, will be apparent from the description, or may be learned by practice of the presented exemplary embodiments.

According to one or more exemplary embodiments, an image forming apparatus includes: a feeding unit configured to feed a recording medium into the image forming apparatus; an image forming unit configured to form an image on the recording medium; a fuser configured to fuse the image formed on the recording medium; a discharging unit configured to discharge the recording medium out of the image forming apparatus; a motor configured to drive at least one of the feeding unit, the image forming unit, the fuser, and the discharging unit, and comprise a rotor including at least one pair of permanent magnets and a Hall sensor measuring a position of the permanent magnets; and a controller configured to drive the motor based on a signal received from the Hall sensor.

According to one or more exemplary embodiments, a method of operating an image forming apparatus, wherein a motor connected to at least one driven object from among a feeding unit, an image forming unit, a fuser, and a discharging unit, is driven, the method includes: obtaining a position of permanent magnets included in the motor by using a Hall sensor; determining a phase of a current to be applied to the motor based on the position of the permanent magnets; and driving the motor by applying a current of the determined phase to the motor.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a diagram for describing an image forming apparatus according to an exemplary embodiment;

FIG. 2 is a structural diagram of an image forming apparatus according to an exemplary embodiment;

FIG. 3 is a diagram for describing an image forming apparatus according to an exemplary embodiment;

FIG. 4 is a detailed diagram for describing a motor according to an exemplary embodiment;

FIG. 5 is a diagram for describing a method of driving a motor according to an exemplary embodiment;

FIG. 6 is a diagram for describing an image forming apparatus according to an exemplary embodiment;

FIG. 7 is a diagram for describing an image forming apparatus according to an exemplary embodiment;

FIG. 8 is a diagram for describing a motor controller according to an exemplary embodiment;

FIG. 9 is a graph for describing an initial driving method of a motor according to an exemplary embodiment;

FIG. 10 is a diagram for describing a method of predicting a load on driven objects according to an exemplary embodiment;

FIG. 11 is a diagram for describing a method of determining a thickness of a fed recording medium, in an image forming apparatus, according to an exemplary embodiment;

FIG. 12 is a diagram for describing a method of determining a thickness of a fed recording medium, in an image forming apparatus, according to another exemplary embodiment;

FIG. 13 is a flowchart of a method of predicting a remaining available use period of driven objects according to an exemplary embodiment;

FIG. 14 is a diagram for describing a method of comparing a load profile with a profile model according to an exemplary embodiment;

FIG. 15 is a diagram for describing a method of calculating a remaining available use period of driven objects according to an exemplary embodiment; and

FIG. 16 is a flowchart of a method of operating an image forming apparatus according to an exemplary embodiment.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description. Expressions such as “at least one of,” when preceding a list of elements, modify the entire list of elements and do not modify the individual elements of the list.

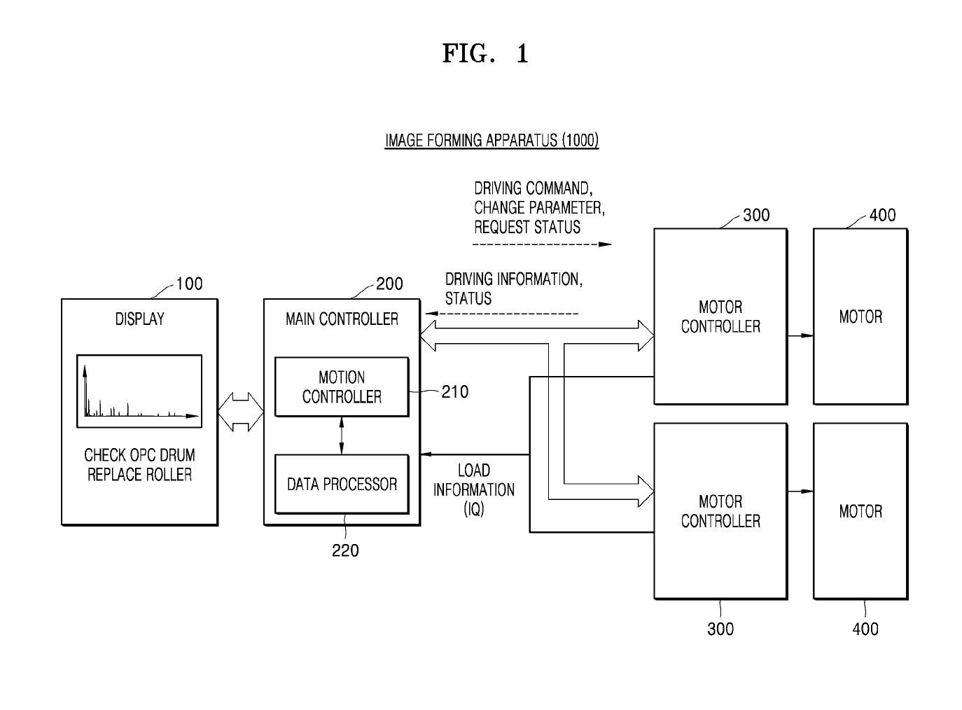

FIG. 1 is a diagram for describing an image forming apparatus 1000 according to an exemplary embodiment. Referring to FIG. 1, the image forming apparatus 1000 includes a display 100, a main controller 200, a motor controller 300, and a motor 400.

The image forming apparatus 1000 may drive driven objects by using the motor 400. The image forming apparatus 1000 may drive the motor 400 at a low speed via vector control. For example, the motor 400 in the image forming apparatus 1000 may rotate at 40 to 500 revolutions per minute (rpm). Also, the motor 400 and the driven objects may rotate at the same speed.

The driven objects indicate at least one of a sheet feeding unit (hereinafter referred to as a “feeding unit”), an image forming unit, a fuser, and a sheet discharging unit (hereinafter referred to as a “discharging unit”). In detail, the driven objects rotated by a motor may be rotating objects included in the feeding unit, the image forming unit, the fuser, and the discharging unit or the like. For example, the driven objects may include at least one roller. The feeding unit may feed a recording medium into the image forming apparatus 1000 and include a pickup roller and a transporting roller. The image forming unit forms an image on the recording medium and includes a photoconductive drum, a transfer roller, a charging roller, or the like. The fuser fuses the image formed on the recording medium, and includes a heating roller and a pressurizing roller. The discharging unit discharges the recording medium from the image forming apparatus 1000 and includes a discharging roller. The rotating objects included in the feeding unit, the image forming unit, the fuser, and the discharging unit or the like may be respectively connected to different motors and may be rotated at different speeds from one another.

The image forming apparatus 1000 may determine an initial position of the motor 400 so as to rotate the motor 400 in a forward or reverse direction, or may hold the motor 400 to maintain the motor 400 at a position.

The motor 400 is driven by the motor controller 300. The motor 400 receives a 3-phase current from the motor controller 300. The motor 400 is rotated according to a magnitude and a phase of an applied current.

The motor controller 300 controls the motor 400. The motor controller 300 determines a position of a permanent magnet to control a rotational direction and a rotational speed of the motor 400.

The main controller 200 controls the motor controller 300. The main controller 200 receives from the motor controller 300 an operating state or load information of the motor 400 or the like and transmits a driving command, a command to change a parameter, a command to change a state of the motor 400 or the like to the motor controller 300.

The main controller 200 includes a motion controller 210 and a data processor 220. The motion controller 210 controls a motion of the motor 400. For example, the motion controller 210 may rotate the motor 400 or cause the motor 400 to vibrate so as to remove paper-flour of the photoconductive drum. The data processor 220 processes load information received from the motor controller 300. The data processor 220 may calculate how to operate the motor 400 based on a magnitude of Iq received from the motor controller 300. Iq is a current applied to the motor 400. Also, the data processor 220 may monitor Iq to determine a thickness of a recording medium or predict a remaining available use period of driven objects. Also, the data processor 220 processes data displayed on the display 100. The data processor 220 may determine a graph or display text or the like to be displayed on the display 100. The data processor 220 may control the display 100 such that the display 100 displays a thickness of a recording medium or a remaining available use period of the driven objects.

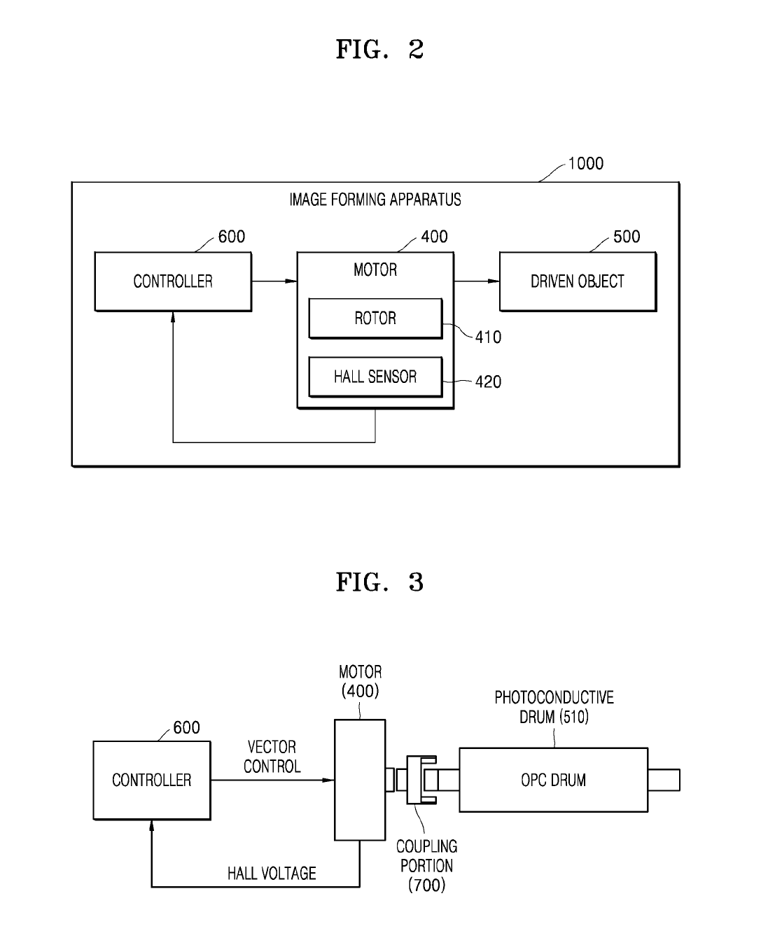

FIG. 2 is a structural diagram of an image forming apparatus 1000 according to an exemplary embodiment. Referring to FIG. 2, the image forming apparatus 1000 obtains a position of a rotor 410 by using a Hall sensor 420. In detail, the image forming apparatus 1000 obtains a position of a permanent magnet included in the rotor 410 by using the Hall sensor 420.

The motor 400 is controlled by using a vector control technique. The vector control technique refers to a technique of driving the motor 400 by applying a 3-phase current to a coil of the motor 400 based on a position of the rotor 410 included in the motor 400. That is, the image forming apparatus 1000 measures a position of the rotor 410 and determines a phase of a current to be applied to the motor 400 based on the position of the rotor 410.

The motor 400 includes the rotor 410 and the Hall sensor 420. The rotor 410 includes at least one pair of permanent magnets and a coil. The rotor 410 is rotated by a current applied to the coil and the permanent magnets. When a current is applied to the coil, the permanent magnets are rotated. The rotor 410 may be connected to a driven object 500.

Three Hall sensors 420 may be disposed at intervals of 120 degrees with respect to an electrical angle. A peripheral area of a pair of permanent magnets may be divided into 360 degrees, and three Hall sensors 420 are disposed at intervals of 120 degrees in the area divided into 360 degrees. The Hall sensors 420 are disposed around the permanent magnets to measure positions of the permanent magnets. The Hall sensors 420 may sense a magnetic field of the permanent magnets and output a signal to the controller 600. For example, the Hall sensors 420 may output a Hall voltage to the controller 600. The number of the Hall sensors 420 is not limited to three.

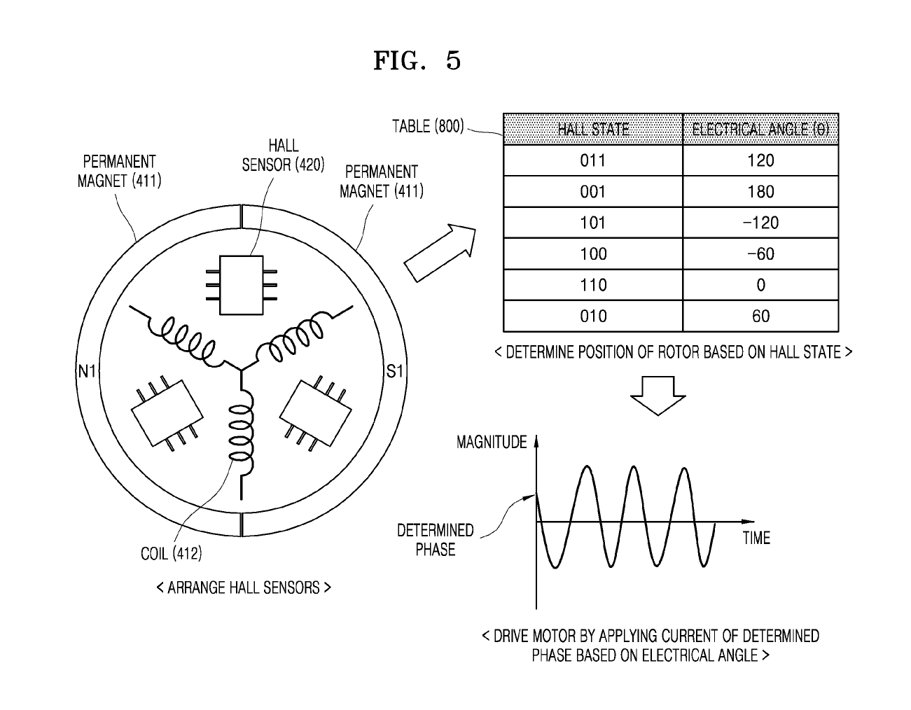

The controller 600 calculates positions of the permanent magnets based on the signal received from the Hall sensors 420. For example, the controller 600 may obtain positions of the permanent magnets based on a Hall state. The controller 600 generates a Hall state based on a Hall voltage received from the Hall sensors 420 and obtains positions of the permanent magnets according to an electrical angle corresponding to the Hall state. The Hall state indicates combination of signals received from the Hall sensors 420. The Hall state will be described in detail with reference to FIG. 5.

The controller 600 determines a phase of a current to be applied to the motor 400 based on the positions of the permanent magnets. The controller 600 determines a phase of a current to be applied to the motor 400 according to the received signals and applies a current of the determined phase to the motor 400 to thereby drive the motor 400.

The driven object 500 is rotated in connection with the motor 400. For example, the driven object 500 may be at least one of a feeding unit, an image forming unit, a fuser, and a discharging unit. In detail, the driven object 500 may be a photoconductive drum (e.g., an organic photo conductor (OPC) drum), a pickup roller, a heating roller, a pressurizing roller, a discharging roller, or an intermediate transfer belt (ITB) included in the feeding unit, the image forming unit, the fuser, and the discharging unit or the like.

The driven object 500 may be directly connected to the motor 400. In other words, the driven object 500 is directly connected to the motor 400 without a gear between the driven object 500 and the motor 400 so that when the motor 400 rotates one time, the driven object 500 also rotates one time. Accordingly, the controller 600 may control a current to be applied to the motor 400 such that the permanent magnets included in the motor 400 rotate at the same speed as a rotational speed of the driven object 500. As no gear is included between the motor 400 and the driven object 500, problems such as noise or reduction in the lifespan of the image forming apparatus 1000 due to a gear may be prevented.

FIG. 3 is a diagram for describing an image forming apparatus according to an exemplary embodiment. Referring to FIG. 3, the motor 400 and a photoconductive drum 510 may be directly connected to each other. Thus, the number of revolutions of the motor 400 and the number of rotations of the photoconductive drum 510 may be the same.

In regard to the exemplary embodiment of FIG. 3, the image forming apparatus 1000 connecting the motor 400 and the photoconductive drum 510 by using a coupling portion 700 is illustrated. The coupling portion 700 connects merely the motor 400 and the photoconductive drum 510 and does not change a rotational ratio between the motor 400 and the photoconductive drum 510 like a gear box. Also, the photoconductive drum 510 is illustrated as an example of the driven object 500 in FIG. 3, and the description with reference to FIG. 3 may be applied not only to the photoconductive drum 510 but also to other rotating objects driven by the motor 400.

The controller 600 controls the motor 400 via vector control. The controller 600 receives a Hall voltage from the motor 400, and controls the motor 400 based on the received Hall voltage.

The motor 400 operates by a 3-phase current received from the controller 600. Each phase of the 3-phase current is determined according to a position of the rotor 410. The motor 400 transmits motive power to the photoconductive drum 510 to rotate the photoconductive drum 510.

The photoconductive drum 510 indicates one of the driven objects 500. The controller 600 rotates the photoconductive drum 510 only in one direction. In order to prevent reverse rotation of the photoconductive drum 510, the controller 600 calculates a position of the rotor 410 to determine a phase of a current so that the rotor 410 rotates in a forward direction, and applies the current of the determined phase to the motor 400. Thus, the motor 400 involving vector control may be applied in driving the photoconductive drum 510.

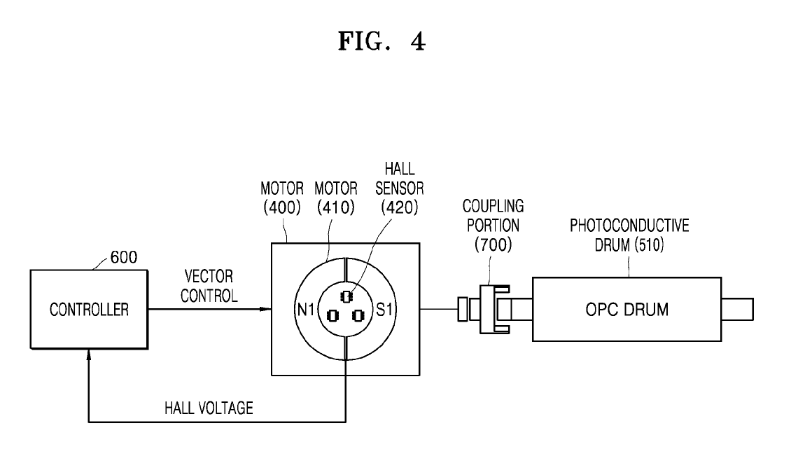

FIG. 4 is a detailed diagram for describing the motor 400 according to an exemplary embodiment. Referring to FIG. 4, the motor 400 includes the rotor 410 and the Hall sensors 420.

The rotor 410 includes a pair of permanent magnets. Although not illustrated in FIG. 4, the rotor 410 further includes a coil around the permanent magnets, and the rotor 410 including the permanent magnets is rotatable.

The Hall sensors 420 are disposed around the permanent magnets. Thus, the Hall sensors 420 measure N-pole and S-pole positions of the permanent magnets. While three Hall sensors 420 are arranged in FIG. 4, the number of the Hall sensors 420 is not limited thereto. Also, while the rotor 410 includes one pair of permanent magnets, the number of permanent magnets included in the rotor 410 is not limited to one pair.

FIG. 5 is a diagram for describing a method of driving a motor according to an exemplary embodiment. Referring to FIG. 5, the image forming apparatus 1000 may drive the motor 400 by using the Hall sensors 420.

The Hall sensors 420 are disposed within a distance from the permanent magnets 411. The Hall sensors 420 are disposed at intervals of 120 degrees. The Hall sensors 420 generate a signal according to a polarity of the permanent magnets 411 to which the respective Hall sensors 420 are close. For example, if the Hall sensor 420 is close to an N-pole, the Hall sensor 420 may output a high signal representing 1, and output a low signal representing 0 when the Hall sensor 420 is close to an S-pole.

The coil 412 is disposed around the magnets, and a 3-phase current received from the controller 600 is applied to the coil 412.

The controller 600 generates a Hall state according to a signal received from the Hall sensors 420. The hall state represents a combination of signals received from the Hall sensors 420. For example, when a signal input from a first Hall sensor 420 is 0, and a signal input from a second Hall sensor 420 is 1, and a signal input from a third Hall sensor 420 is 1, a Hall state is 011.

The table 800 shows electrical angles corresponding to respective Hall states. For example, when a Hall state is 011, an electrical angle is 120 degrees, and when a Hall state is 110, an electric angle is 0 degrees. The Hall sensors 420 are arranged at a predetermined interval around the permanent magnets 411, and thus a Hall state cannot be 000 or 111.

The controller 600 determines a position of the permanent magnets 411 based on a Hall state. The controller 600 may check an electrical angle corresponding to a Hall state by referring to the table 800 and determine a position of the permanent magnets 411 according to the electrical angle.

The controller 600 determines a phase of a 3-phase current to be applied to the coil 412 based on a position of the rotor 410. A rotational direction of the rotor 410 is determined based on the 3-phase current applied to the coil 412. The controller 600 determines the phase of the 3-phase current to be applied to the rotor 410 based on a direction in which the rotor 410 is to be rotated.

The controller 600 drives the motor 400 by applying the 3-phase current of the determined phase to the coil 412. Phases of the 3-phase current differ from one another by 120 degrees.

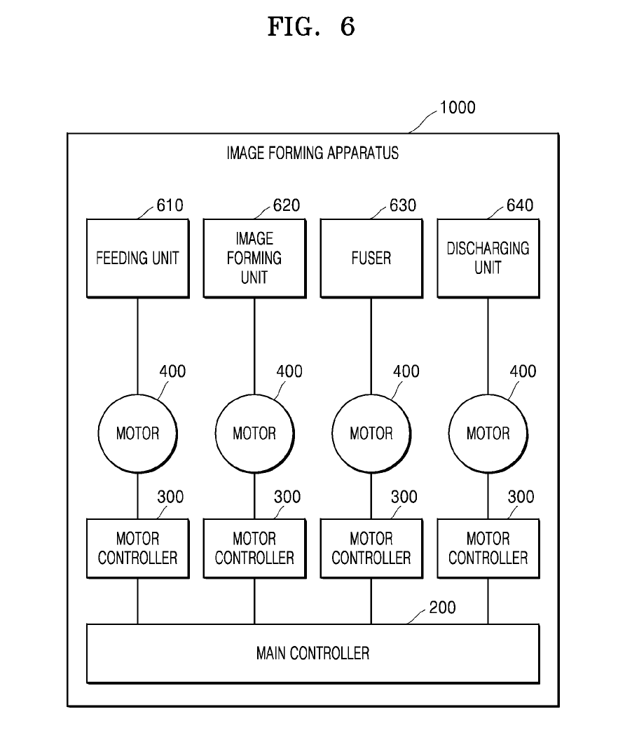

FIG. 6 is a diagram for describing an image forming apparatus 1000 according to an exemplary embodiment. Referring to FIG. 6, the image forming apparatus 1000 includes a plurality of driven objects 500, a plurality of motors 400, and a plurality of motor controllers 300.

The driven objects 500 may be a feeding unit 610, an image forming unit 620, a fuser 630, a discharging unit 640 or the like. The driven objects 500 are respectively connected to different motors 400. Thus, the driven objects 500 may operate at different speeds or in different directions.

The motor controller 300 drives the motor 400. The motor controller 300 applies a 3-phase current to the motor 400 and monitors a state of the motor 400. The motor controller 300 may adjust a magnitude or a phase of the 3-phase current to be applied to the motor 400 based on a monitoring result. For example, the motor controller 300 may adjust a magnitude of the 3-phase current to be applied to the motor 400 in order to maintain a uniform rotational speed of the motor 400.

The main controller 200 controls the motor controllers 300. The main controller 200 determines which of the driven objects 500 to operate from among the feeding unit 610, the image forming unit 620, the fuser 630, and the discharging unit 640, and how to operate the same, and outputs a command to the motor controllers 300. In other words, the main controller 200 controls an overall operation of the driven objects 500.

The main controller 200 may detect an abnormal state of each of the driven objects 500. The main controller 200 may monitor a magnitude of a current applied by the motor controller 300 to the motor 400 to detect an abnormal state of the driven objects 500. For example, if a magnitude of a current applied by the motor controller 300 to the motor 400 exceeds a set range, the main controller 200 may determine that the driven object 500 connected to the motor 400 is in an abnormal state. The main controller 200 may preset a magnitude of a normal-state current for each of the driven objects 500 and monitor the magnitude of the current applied to the motor 400 when driving the motor 400 at a constant speed. When the magnitude of the current applied to the motor 400 deviates from a set range, the main controller 200 may display an abnormal state of the driven objects 500 via the display 100 or stop an operation of the driven objects 500.

For example, the main controller 200 may detect an abnormal state of the feeding unit 610 when the feeding unit 610 simultaneously feeds two or more recording media. When a magnitude of current Iq applied to the feeding unit 610 deviates from a set range, the main controller 200 may stop the feeding unit 610 or rotate the feeding unit 610 in a reverse direction to discharge the fed recording media.

The main controller 200 may detect a thickness of a recording medium. The main controller 200 may monitor a magnitude of a current applied to the motor 400 connected to the feeding unit 610 to detect a thickness of a recording medium picked up by the feeding unit 610.

The main controller 200 may be implemented using at least one processor, and may include a memory. Also, a program for controlling the motor controller 300, the motor 400, or the driven objects 500 may be stored in the memory.

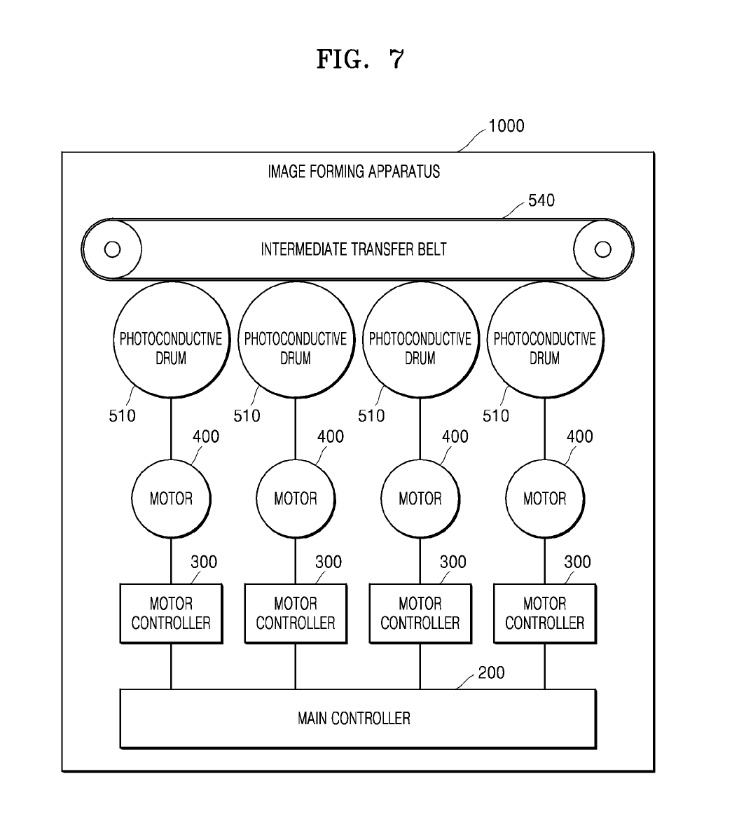

FIG. 7 is a diagram for describing an image forming apparatus 1000 according to an exemplary embodiment. Referring to FIG. 7, the image forming apparatus 1000 may include a plurality of photoconductive drums 510 and a plurality of motors 400 to drive the plurality of photoconductive drums 510.

Each motor controller 300 controls each motor 400 according to a direction provided by the main controller 200. The motor controller 300 may adjust a magnitude of a current to be applied to the motor 400 such that the motor 400 rotates at a uniform speed.

The main controller 200 drives the motor 400 such that the photoconductive drum 510 is rotated according to rotation of an intermediate transfer belt 540. The main controller 200 controls each motor controller 300 by considering a position of a recording medium fed to the intermediate transfer belt 540.

The main controller 200 may determine which of the photoconductive drums 510 is in an abnormal state. The main controller 200 may monitor a current Iq applied to the motor 400 connected to the photoconductive drum 510 to determine the photoconductive drum 510 in an abnormal state.

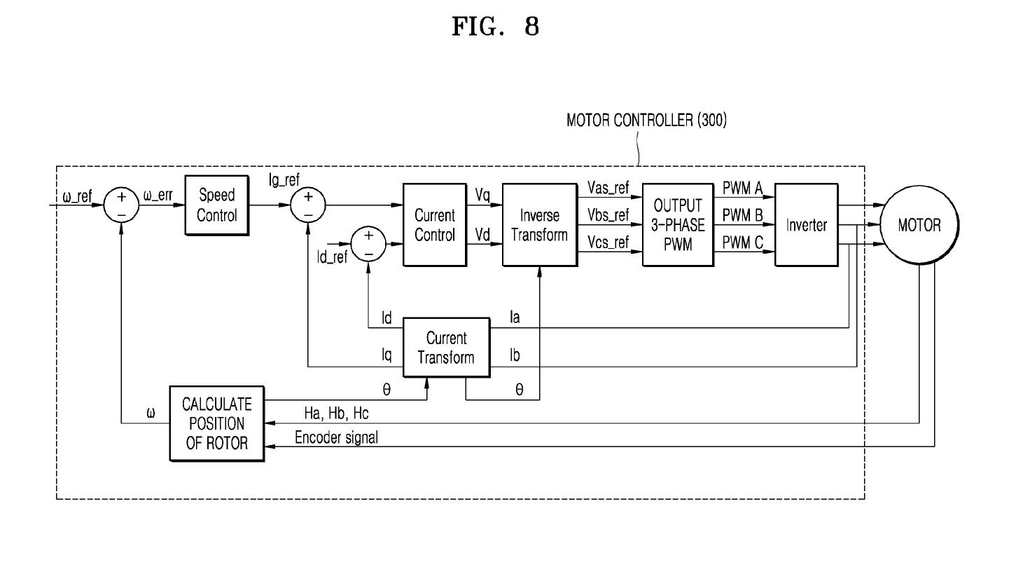

FIG. 8 is a diagram for describing the motor controller 300 according to an exemplary embodiment. The motor controller 300 may calculate a position of the rotor 410 by receiving a Hall voltage, an encoder signal or the like output from the motor 400. Ha, Hb, and Hc or the like indicate Hall voltages. An encoder sensor outputs an encoder signal. The motor controller 300 may initially drive the motor 400 by referring to a Hall voltage, and may drive the motor 400 thereafter by referring to an encoder signal.

The motor controller 300 may determine a phase w according to a position of the rotor 410, and may update a phase of a current applied to the motor 400 by adding the determined phase w to a reference phase ω_ref.

Also, the motor controller 300 adjusts a speed of the motor 400 based on a current Iq or Id. Iq and Id are current applied to the motor 400. Iq is a current of q-axis and Id is a current of d-axis. The motor controller 300 updates a reference current Iq_ref or Id_ref based on measured Iq and Id, and may modify a magnitude of a current applied to the motor 400. The motor controller 300 monitors 3-phase currents Ia, Ib, and Ic applied to the motor 400. The motor controller 300 calculates Id and Iq by transforming the 3-phase currents Ia, Ib, and Ic. The current Iq is a current indicating torque of the motor 400. Thus, the higher Iq is, the greater power is applied to the motor 400. The motor controller 300 may update the magnitude of the current applied to the motor 400 by adding Iq to Iq_ref.

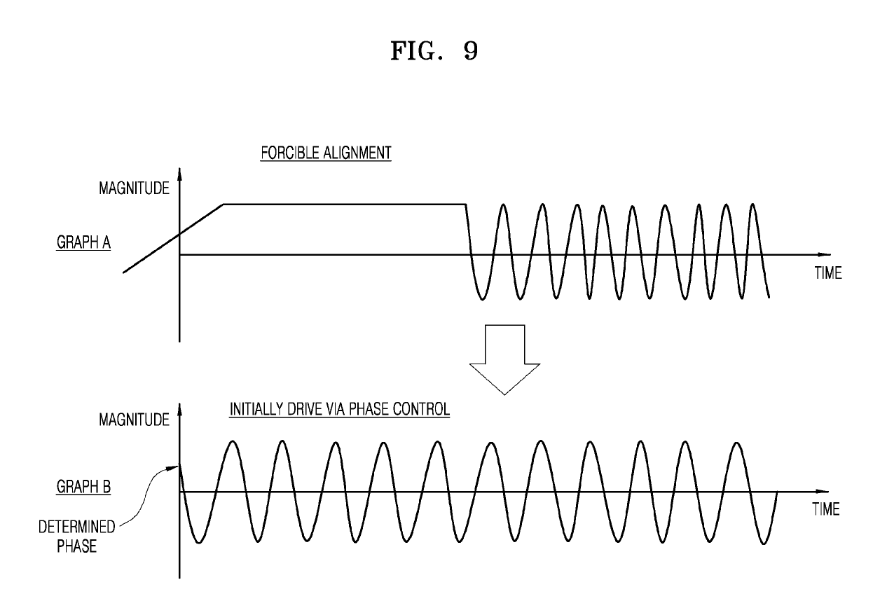

FIG. 9 is a graph for describing a method of initially driving a motor 400 according to an exemplary embodiment. Graph A shows a method of driving the motor 400 via forcible alignment. Graph B shows a method of driving the motor 400 via phase control.

Graph A shows a forcible alignment method used when the controller 600 does not know an initial position of the rotor 410. As the controller 600 does not know the initial position of the rotor 410, the controller 600 applies a direct current (DC) to the rotor 410 to align the rotor 410. In other words, the controller 600 forcibly shifts a position of the rotor 410 to appoint the initial position of the rotor 410.

Graph B shows a phase control method used when the controller 600 knows an initial position of the rotor 410. As the controller 600 knows the initial position of the rotor 410, the controller 600 determines a phase of a current to rotate the rotor 410 in a desired direction, and applies the current of the determined phase to the motor 400. In other words, unlike graph A, the controller 600 may drive the motor 400 by applying an alternating current (AC) to the rotor 410.

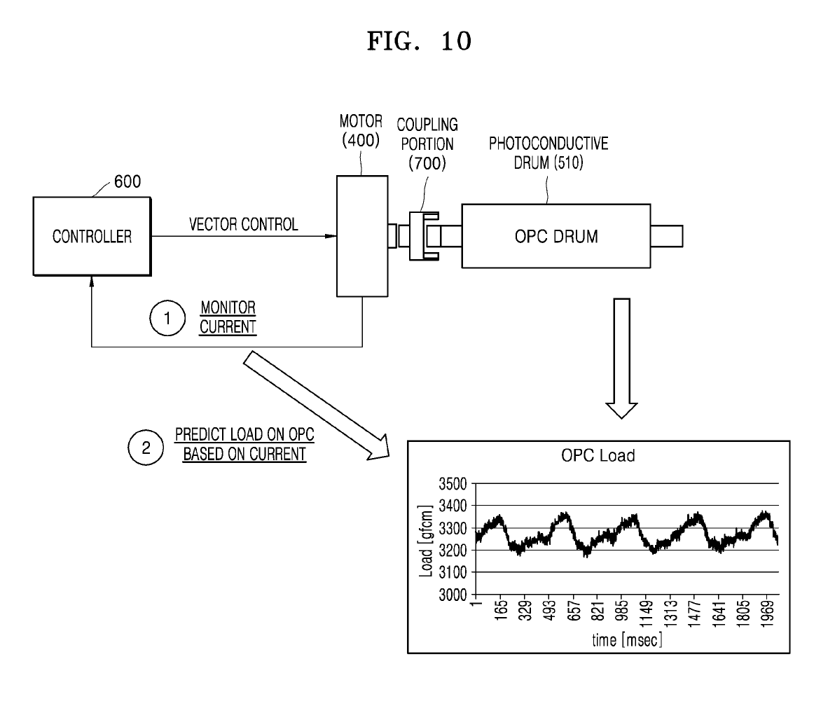

FIG. 10 is a diagram for describing a method of predicting a load on driven objects 500 according to an exemplary embodiment. Referring to FIG. 10, the image forming apparatus 1000 may predict a load on the driven objects 500 based on a magnitude of current applied to the motor 400. FIG. 10 illustrates a photoconductive drum 510 as a driven object 500. Thus, the description with reference to FIG. 10 may also apply not only to the photoconductive drum 510 but also to other rotating objects driven by the motor 400.

The controller 600 monitors a current applied to the motor 400. The controller 600 transforms the 3-phase current applied to the motor 400 to calculate Iq which denotes a q-axis electromotive force. The controller 600 monitors Iq, and predicts a load on the photoconductive drum 510 based on a variation in a magnitude of Iq.

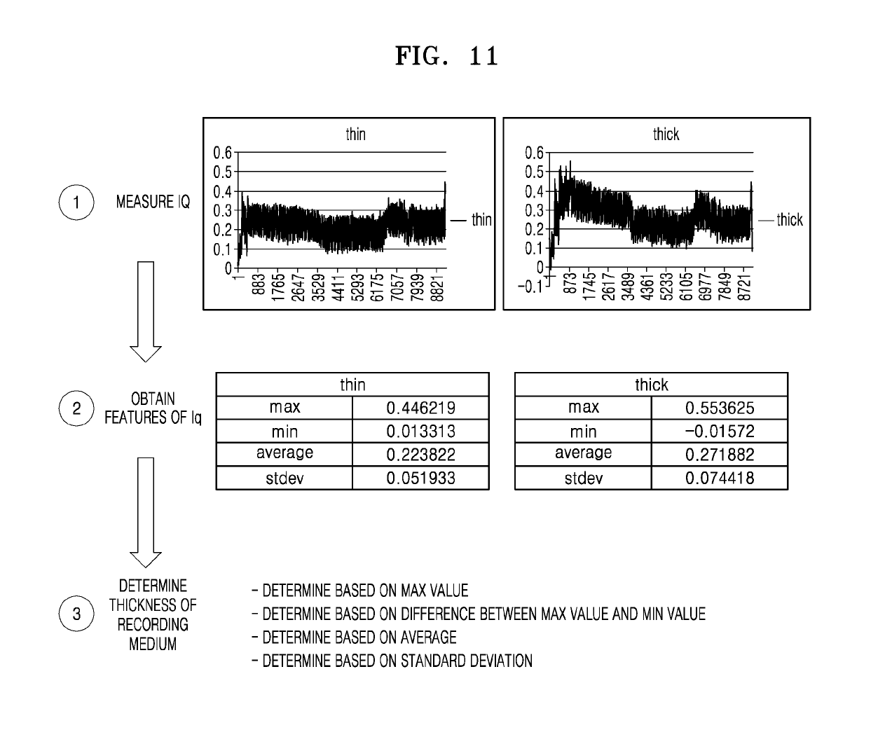

FIG. 11 is a diagram for describing a method of determining a thickness of a fed recording medium, in an image forming apparatus, according to an exemplary embodiment. Referring to FIG. 11, the image forming apparatus 1000 may determine a thickness of a recording medium fed by the feeding unit 610 based on a magnitude of a current applied to the feeding unit 610.

The image forming apparatus 1000 calculates Iq based on a current applied to a motor driving the feeding unit 610 that feeds a recording medium. As shown in the graph illustrated in FIG. 11, a magnitude of Iq varies according to a thickness of the recording medium.

The image forming apparatus 1000 obtains from the graph features indicating when a thin recording medium and a thick recording medium are fed. For example, the image forming apparatus 1000 may obtain a maximum, a minimum, an average, a standard deviation of Iq, or the like.

The image forming apparatus 1000 determines a thickness of a recording medium based on features of Iq. For example, the image forming apparatus 1000 may preset a thickness of a recording medium according to a maximum of Iq, and determine a thickness of a recording medium corresponding to the maximum of the measured Iq to determine the thickness of the fed recording medium. Alternatively, the image forming apparatus 1000 may determine a thickness of a recording medium based on a difference between a maximum and a minimum of Iq and an average of Iq. Alternatively, the image forming apparatus 1000 may determine a thickness of a recording medium based on a standard deviation of Iq. The image forming apparatus 1000 may output the determined thickness of the recording medium via the display 100.

The image forming apparatus 1000 may stop operation of the feeding unit 610 feeding a recording medium, when a thickness of the recording medium is greater than a reference value. When two recording media are fed, the image forming apparatus 1000 may compare features of measured Iq and features of currently measured Iq to determine whether to stop the feeding unit 610. When it is determined that two or more recording media are fed, the image forming apparatus 1000 may stop operation of the feeding unit 610 based on a result of the comparing.

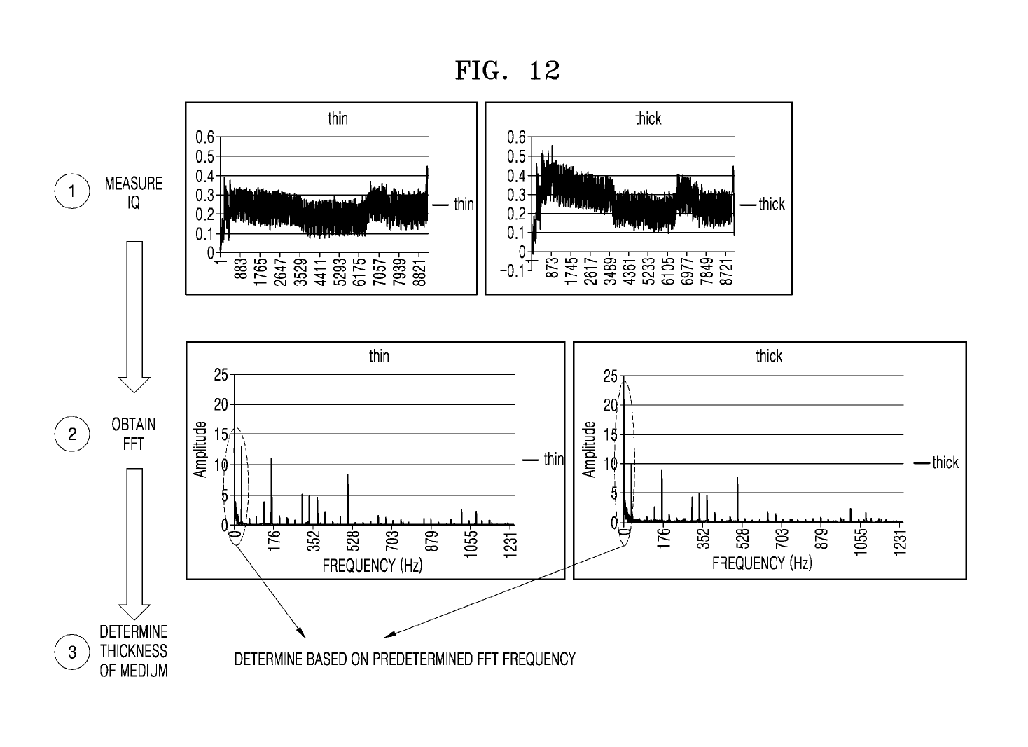

FIG. 12 is a diagram for describing a method of determining a thickness of a fed recording medium, in an image forming apparatus, according to an exemplary embodiment. Referring to FIG. 12, the image forming apparatus 1000 may perform Fourier transformation on a magnitude of a current applied to the feeding unit 610 feeding a recording medium, to determine a thickness of the fed recording medium. The image forming apparatus 1000 performs Fourier transformation on measured Iq for a predetermined period of time. Fourier transformation is a method used to analyze a frequency component of Iq in a temporal domain.

Referring to a Fourier transform graph, a low frequency component of a thin recording medium is smaller than a low frequency component of a thick recording medium. The image forming apparatus 1000 may determine a thickness of a fed recording medium based on a magnitude of a low frequency component. Determination of a thickness of a recording medium based on a low frequency component is an example, and the image forming apparatus 1000 may also determine a thickness of a recording medium by analyzing a predetermined frequency component instead of a low frequency component.

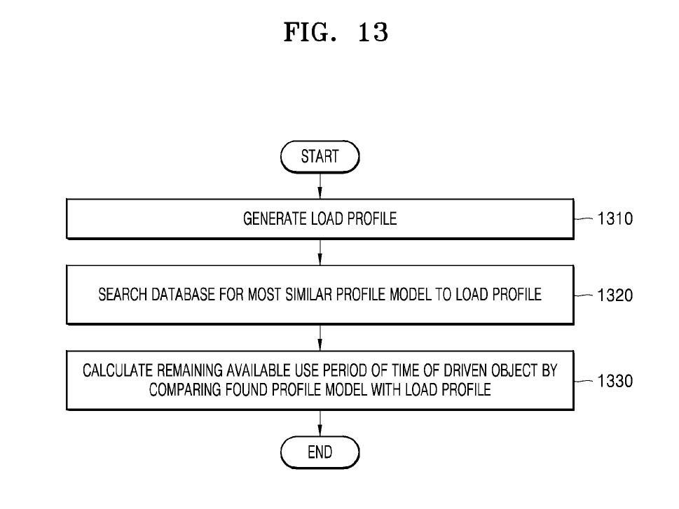

FIG. 13 is a flowchart of a method of predicting a remaining available use period of driven objects 500 according to an exemplary embodiment. Referring to FIG. 13, the image forming apparatus 1000 may generate in advance a profile model of the driven objects 500 and compare the profile model with a load profile of the driven objects 500 to predict a remaining available use period of the driven objects 500.

In operation 1310, the image forming apparatus 1000 generates a load profile of the driven objects 500. The image forming apparatus 1000 monitors a load on the motor 400 connected to the driven object 500 based on a period of use of the driven object 500. For example, the image forming apparatus 1000 may monitor a change in a load on the driven objects 500 by monitoring Iq which is controlled by the controller 600. The image forming apparatus 1000 generates a load profile based on a result of monitoring the load on the driven objects 500. The image forming apparatus 1000 may display magnitudes of Iq according to time in a graph as a load profile of the driven objects 500.

In operation 1320, the image forming apparatus 1000 searches a database for a most similar profile model to the load profile. A memory stores a plurality of profile models. The image forming apparatus 1000 selects one profile model most similar to the load profile from among the plurality of profile models.

In operation 1330, the image forming apparatus 1000 checks a remaining available use period of the driven objects 500 by comparing the load profile with the selected profile model. The remaining available use period refers to a period during which the driven objects 500 may operate normally.

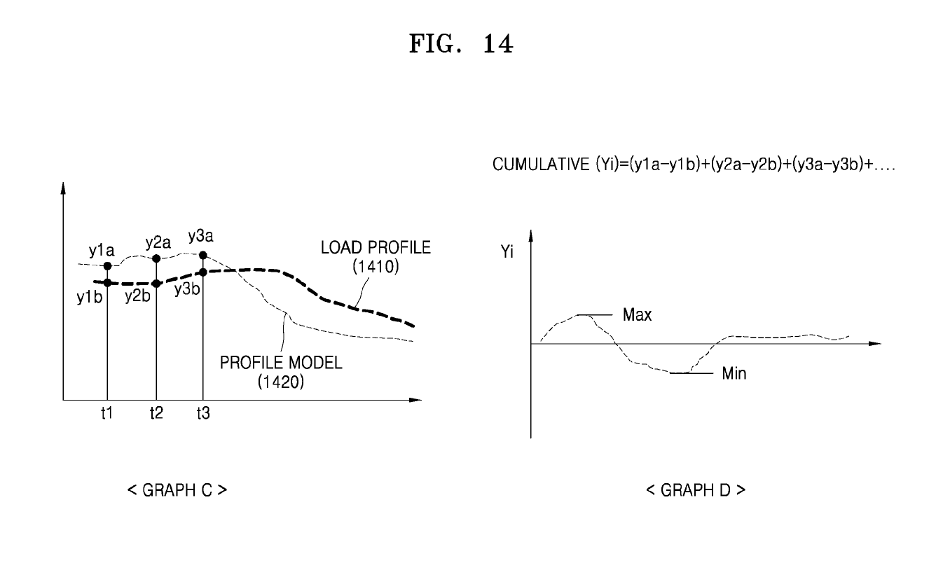

FIG. 14 is a diagram for describing a method of comparing a load profile with a profile model according to an exemplary embodiment. Referring to FIG. 14, the image forming apparatus 1000 may select a profile model 1420 that is most similar to a load profile 1410. The image forming apparatus 1000 generates a graph D in which differences between the load profile 1410 and the profile model 1420 are accumulated. Graph C shows the load profile 1410 and the profile model 1420, and the image forming apparatus 1000 accumulates differences between a value of the load profile 1410 and a value of the profile model 1420 according to respective times t1, t2, t3, . . . . The image forming apparatus 1000 calculates Yi=y1a−y1b at t1, Yi=(y1a−y1b)+(y2a−y2b) at t2, and Yi=(y1a−y1b)+(y2a−y2b)+(y3a−y3b) at t3. The image forming apparatus 1000 obtains a maximum and a minimum of Yi by calculating accumulated values of Yi. The image forming apparatus 1000 may select from among profile models a profile model where the maximum of Yi is the smallest with respect to the minimum of Yi. Also, the image forming apparatus 1000 may select a profile model having a smallest difference between a maximum and a minimum of Yi. Also, the image forming apparatus 1000 may select a profile model having a Yi value that is accumulated as last and is the smallest.

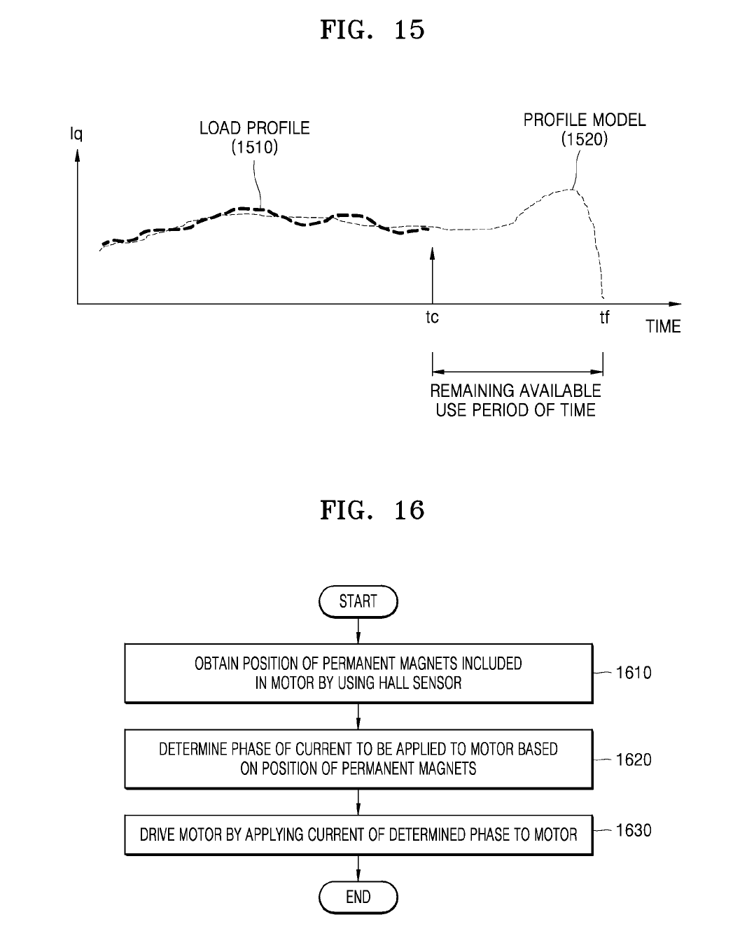

FIG. 15 is a diagram for describing a method of calculating a remaining available use period of driven objects 500 according to an exemplary embodiment. Referring to FIG. 15, the image forming apparatus 1000 compares a load profile 1510 with a profile model 1520. The load profile 1510 is data indicating a change in a load on the driven objects 500 connected to the motor 400, and the profile model 1520 is data obtained and recorded by performing experiments on features of the driven objects 500. The profile model 1520 is a profile model most similar to the load profile 1510 from among a plurality of profile models. Referring to FIG. 15, the load profile 1510 exhibits a similar form up to a ⅔ point of the profile model 1520. Thus, the remaining available use period of time of the driven objects 500 is from a current time tc of the load profile 1510 to a final time tf of the profile model 1520.

FIG. 16 is a flowchart of a method of operating an image forming apparatus 1000 according to an exemplary embodiment. Referring to FIG. 16, the image forming apparatus 1000 may obtain a position of the permanent magnets 411 by using the Hall sensors 420 and may drive the motor 400 based on the obtained position of the permanent magnets 411.

In operation 1610, the image forming apparatus 1000 obtains a position of the permanent magnets 411 included in the motor 400. The image forming apparatus 1000 obtains a Hall state according to a Hall voltage received from the Hall sensors 420 and determines an electrical angle corresponding to the Hall state. The image forming apparatus 1000 may obtain a current position of the permanent magnets 411 based on the electrical angle.

In operation 1620, the image forming apparatus 1000 determines a phase of a current to be applied to the motor 400 based on the position of the permanent magnets 411. The image forming apparatus 1000 determines the phase of the current based on a direction in which the motor 400 is to be rotated. Thus, the image forming apparatus 1000 may prevent reverse rotation of the motor 400. If the photoconductive drum 510 is reversely rotated, the reverse rotation may affect images.

In operation 1630, the motor 400 in the image forming apparatus 1000 is driven by applying a current of the determined phase thereto. The image forming apparatus 1000 may obtain a position of the permanent magnets 411 by using an encoder sensor after the motor 400 has started rotating, and may drive the motor 400 based on a signal received from the encoder sensor.

An image forming apparatus according to an exemplary embodiment may control a motor via phase control.

A motor in an image forming apparatus according to an exemplary embodiment may rotate in a desired direction by obtaining a position of permanent magnets.

A motor in an image forming apparatus according to an exemplary embodiment may be directly connected to a driven object without employing a gear.

An image forming apparatus according to an exemplary embodiment may hold or vibrate a photoconductive drum.

An image forming apparatus according to an exemplary embodiment may calculate a thickness of a recording medium fed using a pickup roller.

An image forming apparatus according to an exemplary embodiment may predict a remaining available use period of time of a driven object based on a variation in a magnitude of a current supplied to the driven object.

The apparatus according to the one or more exemplary embodiments may comprise a processor, a memory for storing program data and executing it, a permanent storage device such as a disk drive, a communications port for handling communications with external devices, and user interface devices, including a communication port for communicating with an external device, a touch panel, a key, or a button, etc. When software modules or algorithms are involved, these software modules may be stored as program instructions or computer readable codes executable on the processor on non-transitory computer-readable media such as magnetic storage media (e.g., read-only memory (ROM), random-access memory (RAM), floppy disks, hard disks, etc.) and optical recording media (e.g., CD-ROMs, DVDs, etc.). The non-transitory computer readable recording medium can also be distributed over network coupled computer systems so that the computer readable code is stored and executed in a distributed fashion. This media can be read by the computer, stored in the memory, and executed by the processor.

Exemplary embodiments may be described in terms of functional block components and various processing steps. Such functional blocks may be realized by any number of hardware and/or software components configured to perform the specified functions. For example, the exemplary embodiments may employ various integrated circuit components, e.g., memory elements, processing elements, logic elements, look-up tables, and the like, which may carry out a variety of functions under the control of one or more microprocessors or other control devices. Similarly, where the elements of the exemplary embodiments are implemented using software programming or software elements the inventive concept may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the exemplary embodiments could employ any number of conventional techniques for electronics configuration, signal processing and/or data processing and the like. The words “mechanism” and “element” are used broadly and are not limited to mechanical or physical embodiments, but can include software routines in conjunction with processors, etc.

The particular implementations shown and described herein are illustrative examples of the inventive concept and are not intended to otherwise limit the scope of the inventive concept in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device.

The use of the terms “a” and “an” and “the” and similar referents in the context of describing the inventive concept (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the inventive concept and does not pose a limitation on the scope of the inventive concept unless otherwise claimed. Numerous modifications and adaptations will be readily apparent to those of ordinary skill in this art without departing from the spirit and scope of the inventive concept.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. An image forming apparatus comprising:
a feeding unit configured to feed a recording medium into the image forming apparatus;
an image forming unit configured to form an image on the recording medium;
a fuser configured to fuse the image formed on the recording medium;
a discharging unit configured to discharge the recording medium out of the image forming apparatus;
a motor including
a rotor including at least one pair of permanent magnets, and
a Hall sensor that outputs a signal indicative of positions of the permanent magnets; and
a controller configured to drive the motor based on the signal output by the Hall sensor, to thereby rotate the rotor and thereby drive at least one of the feeding unit, the image forming unit, the fuser, and the discharging unit.

2. The image forming apparatus of claim 1, wherein the controller
determines a phase of a current to be applied to the motor based on the signal output by the Hall sensor, and
drives the motor by applying the current of the determined phase to the motor.

3. The image forming apparatus of claim 1, wherein the controller generates a Hall state based on a Hall voltage indicated by the signal output by the Hall sensor, and drives the motor according to an electrical angle corresponding to the Hall state.

4. The image forming apparatus of claim 1, wherein a rotational speed of the motor is 50 to 400 revolutions per minute (rpm).

5. The image forming apparatus of claim 1, wherein
the image forming unit includes a photoconductive drum connected to the motor, and
the controller determines a phase of a current to hold the motor according to a current position of the permanent magnets indicated by the signal output by the Hall sensor, and fixes the photoconductive drum by applying a current of the determined phase to the motor.

6. The image forming apparatus of claim 1, wherein
the image forming unit includes a photoconductive drum, and
the controller drives the motor to cause a vibration to thereby remove paper-flour of the photoconductive drum.

7. The image forming apparatus of claim 1, wherein
the feeding unit includes a pickup unit, and
the controller drives the motor by applying a current to the motor to rotate the rotor at a constant speed, and calculates a thickness of a recording medium fed by using the pickup unit by monitoring the current applied to the motor.

8. The image forming apparatus of claim 7, wherein the controller calculates the thickness of the recording medium by performing Fast Fourier Transformation on a result of the monitoring.

9. The image forming apparatus of claim 1, wherein
the at least one of the feeding unit, the image forming unit, the fuser, and the discharging unit includes the feeding unit,
the feeding unit includes a pickup unit connected to the motor, and
the controller drives the motor to cause a vibration so as to separate recording media fed by using the pickup unit from one another.

10. The image forming apparatus of claim 1, wherein the controller predicts a remaining available use period of time of the at least one of the feeding unit, the image forming unit, the fuser, and the discharging unit, by comparing a graph indicating a variation in a magnitude of a current applied to the at least one of the feeding unit, the image forming unit, the fuser, and the discharging unit with a graph obtained by modeling a life cycle of the at least one of the feeding unit, the image forming unit, the fuser, and the discharging unit.

11. The image forming apparatus of claim 1, wherein a rotational ratio between the rotor and the at least one of the feeding unit, the image forming unit, the fuser, and the discharging unit is 1:1.

12. A method comprising:
obtaining, by using a Hall sensor, positions of permanent magnets included in a motor of an image forming apparatus and which is connected to at least one driven object from among a feeding unit of the image forming apparatus, an image forming unit of the image forming apparatus, a fuser of the image forming apparatus and a discharging unit of the image forming apparatus;
determining a phase of a current to be applied to the motor based on the obtained positions of the permanent magnets; and
driving the motor by applying a current of the determined phase to the motor, to thereby drive the at least one driven object to which the motor is connected.

13. The method of claim 12, wherein, in the determining of the phase of the current, the phase of the current to be applied to the motor is determined based on a signal output by the Hall sensor indicative of the positions of the permanent magnets.

14. The method of claim 12, wherein the obtaining of positions of the permanent magnets comprises:
generating a Hall state according to a Hall voltage indicated by a signal output by the Hall sensor;
obtaining an electrical angle corresponding to the generated Hall state; and
obtaining positions of the permanent magnets according to the obtained electrical angle.

15. The method of claim 12, wherein the driving of the motor comprises rotating the motor at 50 to 400 rpm.

16. The method of claim 12, wherein
the at least one driven object includes the image forming unit,
the image forming unit includes a photoconductive drum connected to the motor,
in the determining of a phase of a current, a phase of a current to hold the permanent magnets is determined based on a current position of the permanent magnets as indicated by a signal output by the Hall sensor, and
the method further comprises fixing the photoconductive drum by applying the current of the determined phase to the motor.

17. The method of claim 12, wherein
the at least one driven object includes the image forming unit,
the image forming unit includes a photoconductive drum connected to the motor, and
the driving drives the motor to cause a vibration to thereby remove paper-flour of the photoconductive drum.

18. The method of claim 12, wherein:
the at least one driven object includes the feeding unit,
the feeding unit includes a pickup unit connected to the motor, and
the method further comprises
monitoring the current applied to the motor while the motor rotates at a constant speed, and
calculating a thickness of a recording medium fed by using the pickup unit based on a result of the monitoring.

19. A non-transitory computer readable recording medium having recorded thereon a program for executing the method of claim 12.

20. An image forming apparatus comprising:
a feeding unit configured to feed a recording medium into the image forming apparatus;
an image forming unit configured to form an image on the recording medium;
a fuser configured to fuse the image formed on the recording medium;
a discharging unit configured to discharge the recording medium out from the image forming apparatus;
a motor including a rotor that includes permanent magnets, the rotor being rotatable to thereby drive a driven object from among the feeding unit, the image forming unit, the fuser, and the discharging unit; and
a controller configured to control a rotational direction and a rotational speed of the rotor based on positions of the permanent magnets,
wherein a rotational ratio between the rotor and the driven object is 1:1.
